(19) United States
(12) Patent Application Publication
(10) Pub. No.: US 2009/0053416 A1
(43) Pub. Date: Feb. 26, 2009

(54) Camouflage mask and method of mask use

(76) Inventor: Irina Iosilevich, Boca Raton, FL (US)

Correspondence Address: FRANK L. KUBLER, 13261 S.W. 54th Court, Miramar, FL, 33027, US

(21) Appl. No.: 11/982,506

(22) Filed: Nov. 2, 2007

Related U.S. Application Data
(60) Provisional application No. 60/876,634, filed on Dec. 22, 2006.

(51) Int. Cl. B05D 5/00; B05C 11/10; B05C 13/00; B05C 1/00

(52) U.S. Cl. 427/256; 118/200; 118/13; 118/211; 118/264

(57) ABSTRACT

An apparatus for retaining and transferring a selected pattern of pigment material to a target surface including a quantity of pigment material; and a mask formed of substrate sheet having a forward contact surface on which a selected pattern of the pigment material is deposited and a rearward surface. The apparatus preferably additionally includes a cover sheet removably covering the contact surface, for preventing unwanted pigment transfer and smearing of the pigment pattern.

### FILING HISTORY

The present application continues from provisional application Ser. No. 60/876,634 filed on Dec. 22, 2006.

### BACKGROUND OF THE INVENTION

1. Field of the Invention

The present invention relates generally to the field of cosmetics application devices and methods. More specifically the present invention relates to an apparatus for retaining and transferring a selected pattern of pigment material such a camouflage pattern to a target surface such as a human face. In general terms, the apparatus includes a mask formed of a substrate sheet having a forward contact surface on which a selected pattern of pigment material is deposited such as during manufacture, and a rearward surface. The method of use includes steps of placing the contact surface against the target surface, and uniformly press the contact surface against the target surface and thereby transfer some of the pigment material to reproduce the selected pattern on the target surface. The mask optionally is rubbed on the rearward surface with very slight lateral movement to help transfer the pigment material. The contact surface preferably is covered with a removable cover sheet which prevents unwanted pigment transfer and smearing of the pigment pattern. The cover sheet is pealed off the contact surface for mask use.

2. Description of the Prior Art

There have long been pigment containers such as tubes and cans of various paints and dyes for application to human skin to produce a camouflage pigment pattern or a dramatic or ceremonial pigment pattern for the stage.

Camouflage is necessary for deception and often is used by humans for disguise and protection in recreational hunting and for military purposes. For years two people have been needed to apply face paint to each other to camouflage the faces. Generally such paints are solid colors of black, brown and green.

A problem with these pigment materials has been that the quality the pattern produced depends entirely on the skill and patience of the person applying them, even though the life of a soldier and the success of a mission may depend on the quantity of the pattern. Another problem is that it takes time to create a desired pattern, and the needed time may not be available. Yet another problem has been that either a second person or a mirror normally is needed to create and verify the quality of the result. Furthermore the empty containers have to be carried so that no evidence of a traveled path or location remains to be found. Finally the paints used can stain the skin and be difficult to remove.

It is thus an object of the present invention to provide a mask apparatus for applying a pigment pattern such as camouflage which is pre-formed to a target surface such as a human face.

It is another object of the present invention to provide such a mask apparatus which applies a desired pigment pattern exactly as designed without regard for the level of skill or the patience of the person using the mask apparatus, and which does so in very minimal time.

It is still another object of the present invention to provide such a mask apparatus which is easily removed with make-up remover, is provided in different shapes and sizes, is light-weight and requires no boxes, cans or tubes to pack or carry, and which is resistant to wear and to large temperature variations.

It is finally an object of the present invention to provide such a mask apparatus which is relatively inexpensive to manufacture.

### SUMMARY OF THE INVENTION

The present invention accomplishes the above-stated objectives, as well as others, as may be determined by a fair reading and interpretation of the entire specification.

An apparatus for retaining and transferring a selected pattern of pigment material to a target surface including a quantity of pigment material; and a mask formed of a substrate sheet having a forward contact surface on which a selected pattern of the pigment material is deposited and retained, and having a rearward surface.

The apparatus preferably additionally includes a cover sheet removably covering the contact surface, for preventing unwanted pigment transfer and smearing of the pigment pattern. The substrate sheet preferably is one of: gauze, fabric, sponge, felt and foam. The substrate sheet and the quantity of pigment material optionally are formed of edible material. The substrate sheet optionally is formed of water soluble material. The apparatus optionally additionally includes a pouch for retaining the mask.

The substrate sheet optionally is formed of a fabric containing a moisture barrier and stabilizers. The stabilizers preferably include one of: pellon, permanent stabilizers, a light-weight water soluble stabilizer, a heavier weight denser water soluble stabilizer, and a heat disintegrating brush-away stabilizer. The pigment pattern optionally is one of: woodland, desert, snow coverage, and pixilated patterns, abstract or random patterns, selected according to climate, seasons and habitat. The quantity of pigment material preferably is removable with make-up remover. The substrate sheet and the quantity of pigment material preferably are formed of natural and environmentally safe components. The mask optionally includes a scent producing material. The mask optionally includes a scent suppressing component. The contact surface optionally is coated with at least one of: transferable insect repellant and sun protective material. The mask optionally includes a setting powder to make the quantity of pigment material waterproof and sweat proof, and to make the quantity of pigment material produce a mat finish to eliminate shine and reduce reflectivity.

A method is provided of using an apparatus including a quantity of pigment material, and a mask formed of substrate sheet having a forward contact surface on which a selected pattern of the pigment material is deposited and a rearward surface, including the steps of: placing the contact surface against the target surface; and uniformly pressing the contact surface against the target surface and thereby transferring some of the pigment material to reproduce the selected pattern on the target surface. Where a cover sheet initially covers the contact surface, the method includes the additional step of: removing the cover sheet from the contact surface.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a front view of a user face with pigment material in a camouflage pattern deposited by the mask shown beside the user with the cover sheet partly pealed back from the forward contact surface.

FIG. 2 is a plan view of the contact face present mask having a first exemplary pigment material camouflage pattern on its contact surface.

FIG. 3 is a perspective view of the mask pouch for carrying the mask until it is needed, and of the mask folded several times and poised for insertion into the open mask pouch.

FIG. 4 is a second exemplary pigment material camouflage pattern.

FIG. 5 is a third exemplary pigment material camouflage pattern.

FIG. 6 is a plan view of a preferred substrate sheet shape having markings for alignment with the nose and mouth areas of a user face, and optionally having cut-out eye openings and a cut-out nose flap.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

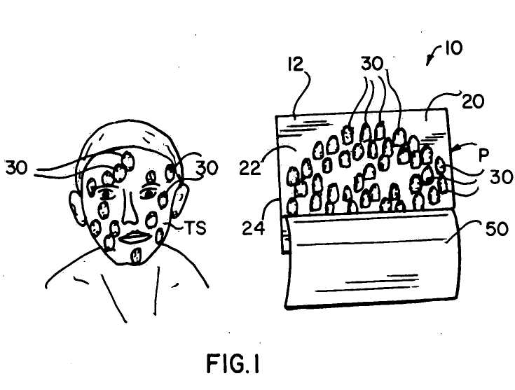

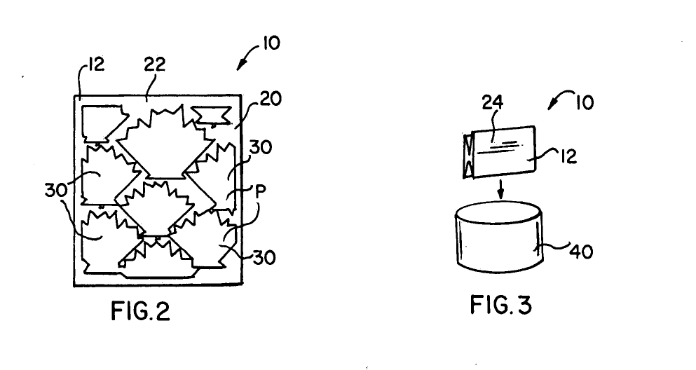

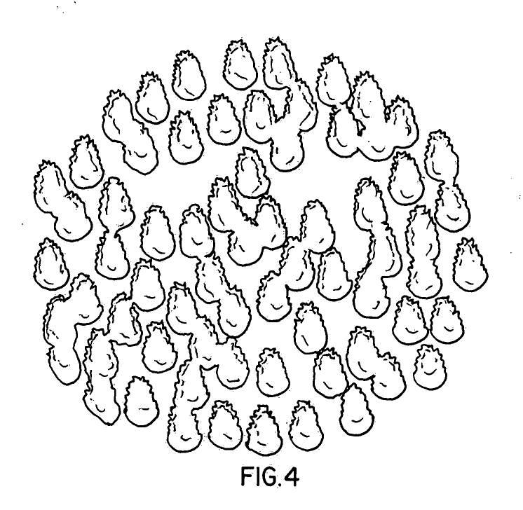

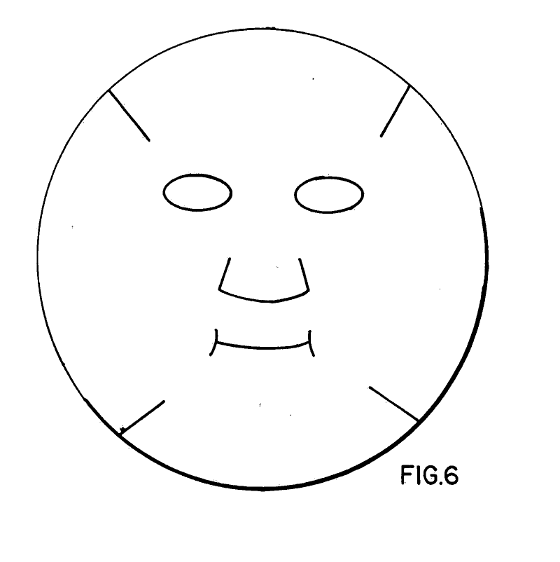

Referring to FIGS. 1-6, a camouflage apparatus in the form of an apparatus 10 is disclosed for retaining and transferring a selected pattern P of pigment material such a camouflage pattern to a target surface TS such as a human face.

In general terms, the apparatus 10 includes a mask 12 formed of a substrate sheet 20 having a forward contact surface 22 on which a selected pattern of pigment material 30 is deposited such as during manufacture, and a rearward surface 24.

The substrate sheet 20 preferably is a sheet of one of: gauze, fabric, sponge, felt and foam, and is provided in any of a variety of shapes and sizes as needed. The mask 12 optionally is folded several times, preferably eight times, and is placed into a mask pouch 40 such as a zip-lock bag. The substrate sheet 20 optionally is formed of material which can be eaten or dissolved in water or in urine so that no evidence is left behind of the presence of the user, such as soldiers, or put back into the mask pouch 40. The substrate sheet 20 optionally is a fabric with a moisture barrier containing stabilizers. Examples of suitable stabilizers include pellon, permanent stabilizers, a light-weight water soluble stabilizer, a heavier weight denser water soluble stabilizer, and a heat disintegrating brush-away stabilizer.

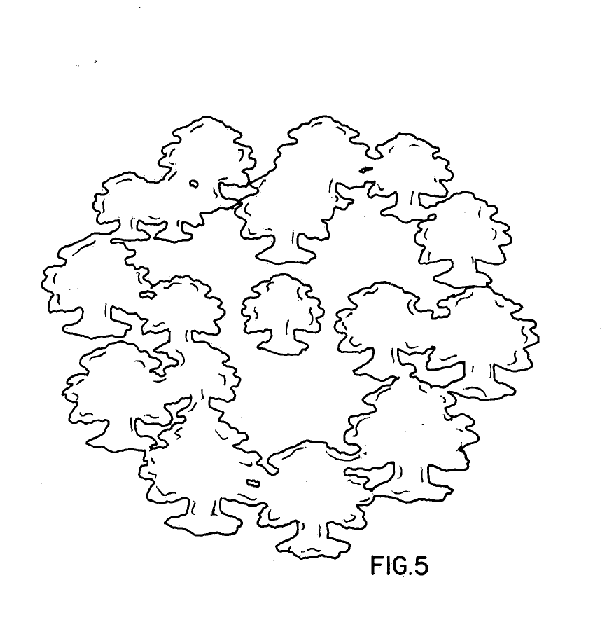

Contemplated target surfaces TS in addition to a human face include the neck, ears and hands of a person such as a hunter or soldier. Examples of camouflage pigment patterns P are shown in FIGS. 4-6, and examples might include but not be limited to woodland, desert, snow coverage, and pixilated patterns, abstract or random patterns, selected according to climate, seasons and habitat. For camouflage purposes the pigment material 30 colors and pattern P preferably are selected to blend with or duplicate the colors of user clothing.

The composition of the pigment material 30 preferably is selected so that the pigment material 30 is easily removable with make-up remover. All parts of apparatus 10 include the substrate sheet 20 and the pigment material 30 preferably are made of natural and environmentally safe components, and are resistant to wear and to large temperature variations.

For hunting and military uses in particular, the pigment material 30 may contain any of a variety of scents or lures so that a scented mask 12 suitable for a given use may be selected. Scent suppressing components are optionally provided as well. The contact surface 22 optionally is coated with transferable insect repellant or sun protective material. As an alternative to uniformly coating the entire contact surface 22 with these substances, any one or more of these substances optionally is mixed with the pigment material 30 forming the pattern P. A setting powder is optionally is applied over the mask 12 to make the pigment material 30 waterproof and sweat proof, and to make it produce a mat finish to eliminate shine and reduce reflectivity which could undermine the effect of the camouflage pattern P.

### Method

In practicing the invention, the following method may be used. The method of use includes steps of: placing the contact surface 22 against the target surface TS, and uniformly press the contact surface 22 against the target surface TS and thereby transfer some of the pigment material 30 to reproduce the selected pattern P on the target surface TS. The mask 12 optionally is rubbed on the rearward surface 24 with very slight lateral movement to help transfer the pigment material 30. The contact surface 22 preferably is covered with a removable cover sheet 50 which removably clings or is adhesively bonded to the contact surface 22 and prevents unwanted pigment material 30 transfer and smearing of the pigment pattern P. The cover sheet 50 is pealed off the contact surface 22 for mask 12 use.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An apparatus for retaining and transferring a selected pattern of pigment material to a target surface, comprising:
a quantity of pigment material;
and a mask formed of a substrate sheet having a forward contact surface on which a selected pattern of said pigment material is deposited and retained, and having a rearward surface.

2. The apparatus of claim 1, additionally comprising a cover sheet removably covering said contact surface, for preventing unwanted pigment transfer and smearing of the pigment pattern.

3. The apparatus of claim 1, wherein said substrate sheet is one of: gauze, fabric, sponge, felt and foam.

4. The apparatus of claim 1, wherein said substrate sheet and said quantity of pigment material are formed of edible material.

5. The apparatus of claim 1, wherein said substrate sheet is formed of water soluble material.

6. The apparatus of claim 1, additionally comprising a pouch for retaining said mask.

7. The apparatus of claim 1, wherein said substrate sheet is formed of a fabric containing a moisture barrier and stabilizers.

8. The apparatus of claim 7, wherein said stabilizers comprise one of: pellon, permanent stabilizers, a light-weight water soluble stabilizer, a heavier weight denser water soluble stabilizer, and a heat disintegrating brush-away stabilizer.

9. The apparatus of claim 1, wherein said pigment pattern is one of: woodland, desert, snow coverage, and pixilated patterns, abstract or random patterns, selected according to climate, seasons and habitat.

10. The apparatus of claim 1, wherein said quantity of pigment material is removable with make-up remover.

11. The apparatus of claim 1, wherein said substrate sheet and said quantity of pigment material are formed of natural and environmentally safe components.

12. The apparatus of claim 1, wherein said mask comprises a scent producing material.

13. The apparatus of claim 1, wherein said mask comprises a scent suppressing component.

14. The apparatus of claim 1, wherein said contact surface is coated with at least one of: transferable insect repellant and sun protective material.

15. The apparatus of claim 1, wherein said mask comprises a setting powder to make said quantity of pigment material waterproof and sweat proof, and to make said quantity of pigment material produce a mat finish to eliminate shine and reduce reflectivity.

16. A method of using an apparatus comprising a quantity of pigment material, and a mask formed of substrate sheet having a forward contact surface on which a selected pattern of the pigment material is deposited and a rearward surface, comprising the steps of:
placing the contact surface against the target surface;
and pressing the contact surface against the target surface and thereby transferring at least some of the pigment material to reproduce the selected pattern on the target surface.

17. The method of claim 15, wherein a cover sheet initially covers the contact surface, comprising the additional step of:
removing the cover sheet from the contact surface.
